(19) United States
(12) Patent Application Publication
(10) Pub. No.: US 2002/0148338 A1
(43) Pub. Date: Oct. 17, 2002

(54) Cutting apparatus for transverse curtain lath

(76) Inventor: Shien-Te Huang, Taipei (TW)

Correspondence Address: HUANG, Shien-Te, P. O. Box No. 6-57, Chung-Ho City, TAIPEI HSIEN 235, TW

(21) Appl. No.: 09/834,935

(22) Filed: Apr. 16, 2001

(51) Int. Cl. B26D 1/06

(52) U.S. Cl. 83/631; 83/694

(57) ABSTRACT

A cutting apparatus for transverse curtain lath is proposed to cut the curtain materials in transverse direction. The cutting apparatus comprises a station with driving thread rod linked to a driving tenon in the station and driving a cutting board; the cutting board sliding on a cutting surface in front of the station. The station has a feeding table on backside thereof. The driving thread rod is operated by a handle to perform linear operation. The cutting apparatus has simple structure and easy operation.

### BACKGROUND OF THE INVENTION

1. Field of the Invention

The present invention relates to a cutting apparatus for transverse curtain lath, especially to a cutting apparatus for transverse curtain lath, which has simple structure and easy operation.

2. Description of the Prior Art

FIGS. 1 to 3 show the conventional cutting apparatus. FIG. 1 shows the swing handle type cutting apparatus, which comprises a station 7, a swing handle 71 atop the station 7 and pivotal to one end of the station 7. The swing handle 71 drives a sliding plate 8 through a link rod 72. The sliding plate 8 has a cutting blade 81 and the station 7 has an upper groove 93, a lower groove 91 and a through groove 92 for curtain laths, through which the curtain lath pass. By pressing the swing handle 71, the sliding plate 8 moves the cutting blade 81 to cut the curtain laths. Due to the swing handle 71, the swing handle type cutting apparatus needs a large space. The cutting force is magnified by the lever arm of the swing handle 71. The swing handle type cutting apparatus is hard to temporarily cease the cutting force. FIG. 2 shows a hand-wheel type cutting apparatus. The hand-wheel type cutting apparatus has a hand wheel 14 driving a worm 75 to rotate a cam 73. The cam 73 drives a sliding plate 8 to press an abutting rod 84 such that the sliding plate 8 is moved laterally. The sliding plate 8 is slidably arranged on the station 7. The station 7 also has an upper groove 93, a lower groove 91 and a through groove 92 atop the sliding plate 8; and cutting blade 81 to cut the curtain laths. The cam 73 increase friction and the hand-wheel type cutting apparatus has complicated structure. FIG. 3 shows an electrical type cutting apparatus. The electrical type cutting apparatus also has a station 7 and an upper groove 93, a lower groove 91 and a through groove 92. The electrical type cutting apparatus has an electro motor 83 slidably arranged on a sliding rail 76. The output of the electro motor 83 is connected to a circular saw 82 to vertically cut the curtain laths out of the grooves. However, the blade is driven by the electro motor 83, noise is generated and electrical power is required. The electrical type cutting apparatus should be operated by special technician.

### SUMMARY OF THE INVENTION

It is the object of the present invention to provide a cutting apparatus with simple structure and easy operation.

To achieve the above object, the present invention provides a cutting apparatus for transverse curtain lath. The cutting apparatus comprises a station with driving thread rod linked to a driving tenon in the station and driving a cutting board; the a cutting board sliding on a cutting surface in front of the station. The station has a feeding table on backside thereof. The driving thread rod is operated by a handle to perform linear operation. The cutting apparatus has simple structure and easy operation.

The various objects and advantages of the present invention will be more readily understood from the following detailed description when read in conjunction with the appended drawing, in which:

### BRIEF DESCRIPTION OF THE DRAWINGS

FIG. 1 shows the front view of a prior art cutting apparatus;

FIG. 2 shows the front view of another prior art cutting apparatus;

FIG. 3 shows the front view of another prior art cutting apparatus;

FIG. 4 shows the perspective view of the cutting apparatus of the present invention;

FIG. 5 shows the cutting board of the cutting apparatus of the present invention;

FIG. 6 shows the cutting board and the cutting surface of the cutting apparatus of the present invention;

FIG. 7 shows the cutting board of the cutting apparatus of the present invention before cutting operation;

FIG. 8 shows the backside of the station;

FIG. 9 shows the locking means of the present invention;

FIG. 10 is a top view showing the station and the curtain materials;

FIG. 11 shows the block ruler of the present invention;

FIG. 12 shows the blade of the present invention.

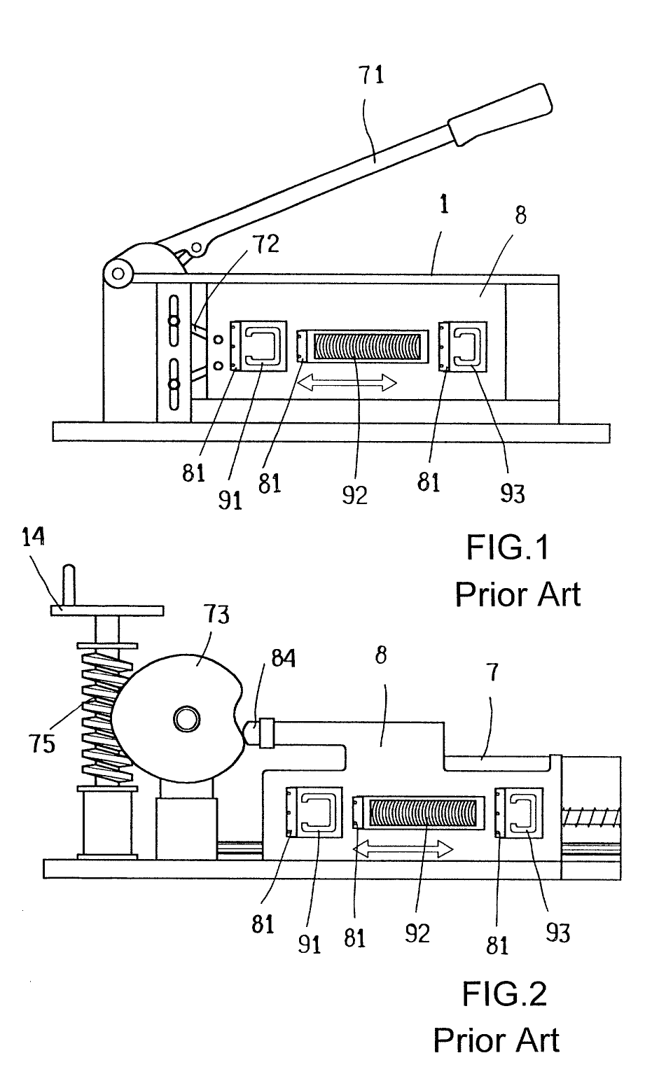

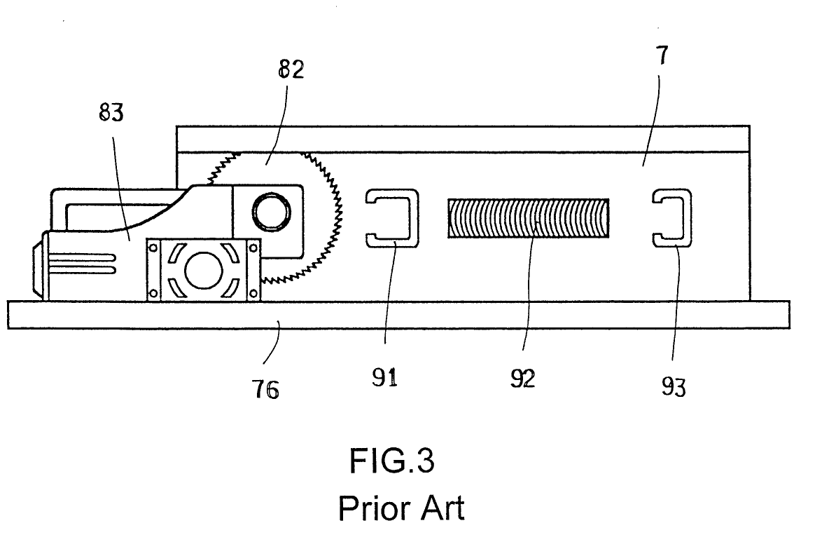

### DETAILED DESCRIPTION OF THE PREFERRED EMBODIMENTS

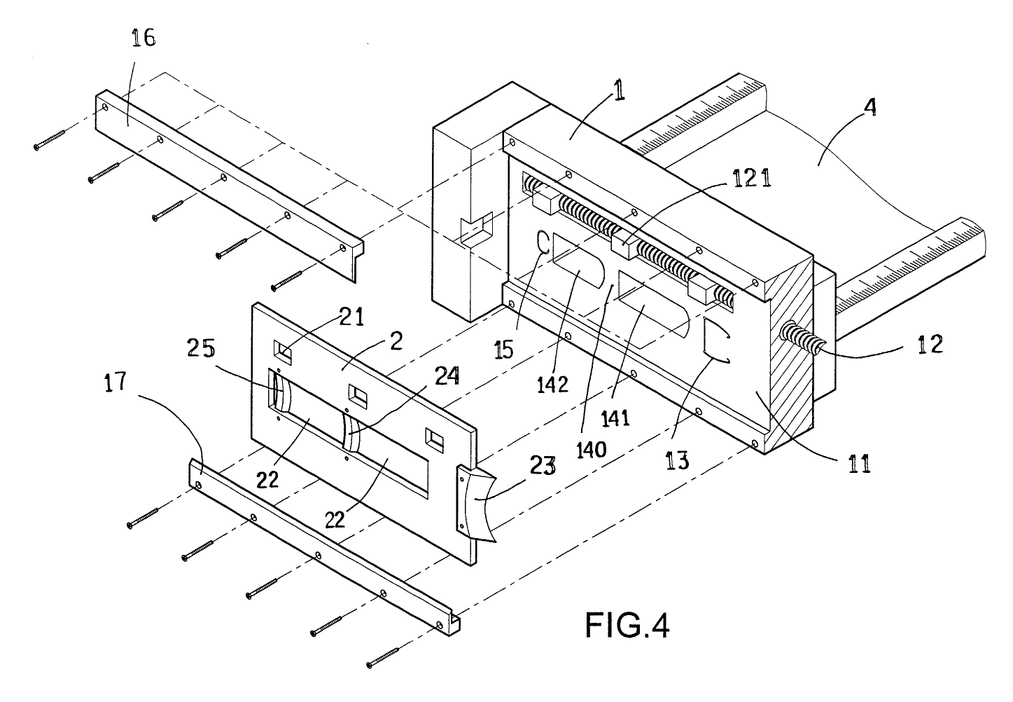

As shown in FIG. 4, the cutting apparatus of the present invention has a rectangular station 1 and a cutting surface 11 in front of the rectangular station 1. The cutting surface 11 has a cutting board 2 sliding thereon. The rectangular station 1 has a thread rod 12 thereon, the thread rod 12 has a driving tenon 121 inside the rectangular station 1. The driving tenon 121 is driven by the thread rod 12 to move laterally. The driving tenon 121 is fit into a mortise 21 of the cutting board 2. The cutting board 2 is inward pressed and locked by an upper board 16 and a lower board 17 such that the cutting board 2 is limited laterally by the cutting surface 11. The cutting board 2 has an opening 22 for the curtain laths. The cutting board 2 has an upper rail blade 23 and lath-forming blade 24 and lower rail blade 25 corresponding to the cutting board 2. The rectangular station 1 further has an upper groove 13, front groove 141, rear groove 142 and a lower groove 15. The front groove 141 and the rear groove 142 is separated by a baffle plate 140 and two grooves are formed for the lath-forming blade 24 and the lower rail blade 25 to cut two groups of curtain laths. The cutting stroke and cutting time are saved.

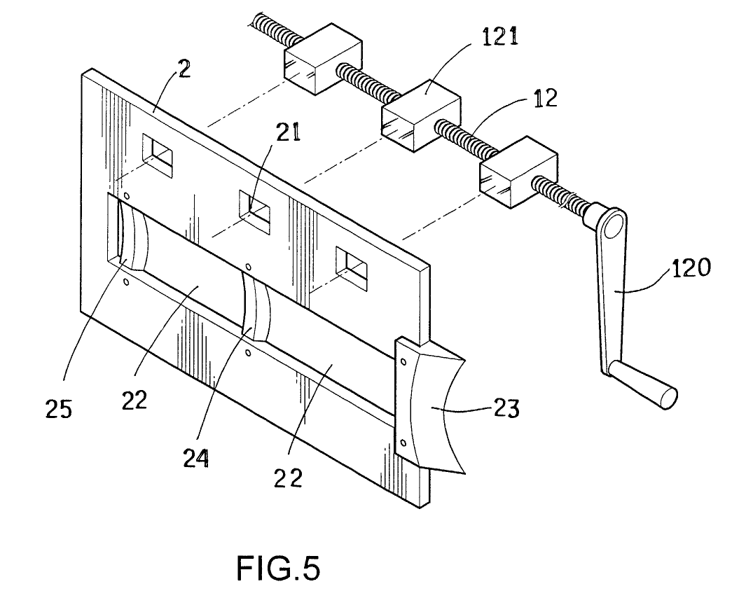

With reference now to FIG. 5, the thread rod 12 is driven by a handle 120. The driving tenon 121 is screwed to the thread rod 12. When the thread rod 12 is rotated, the driving tenon 121 is moved laterally. By the lateral movement and the driving tenon 121 being fit to the mortise 21 of the cutting board 2, the cutting board 2 is also driven. The upper rail blade 23 and lath-forming blade 24 and the lower rail blade 25 are also driven to cut the curtain laths.

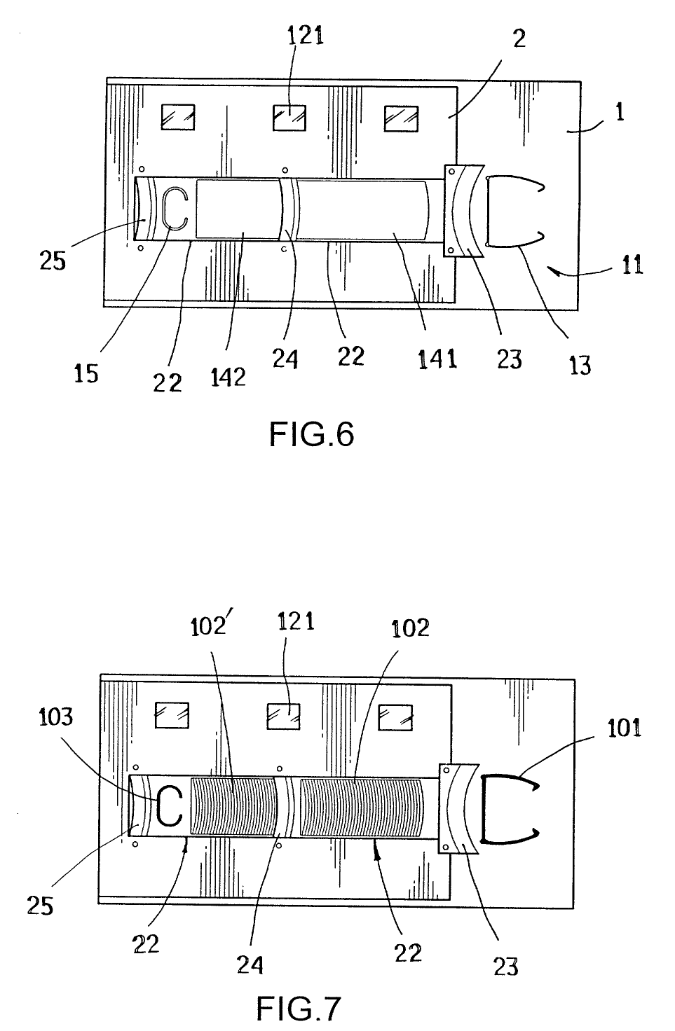

With reference now to FIG. 6, the cutting board 2 is laid against the cutting surface 11 and the opening 22 is corresponding to the grooves of the station 1. The upper groove 13 is corresponding to the right side of the upper rail blade 23; the lath-forming blade 24 is corresponding to the front groove 141; the lower rail blade 25 is corresponding to the rear groove 142 and the lower groove 15.

With reference now to FIG. 7, the upper rail material 101 is passed through the above-mentioned groove and the identical laths 102 and 102′ are grouped to front bundle and rear bundle and pass through the opening 22, respectively. The rear bundles of laths are cut with the lower rail material 103 by the lower rail blade 25. The whole bundles of laths 32 are classified into to bundles and cut by the lath-forming blade 24 and the lower rail blade 25 to save half the stroke.

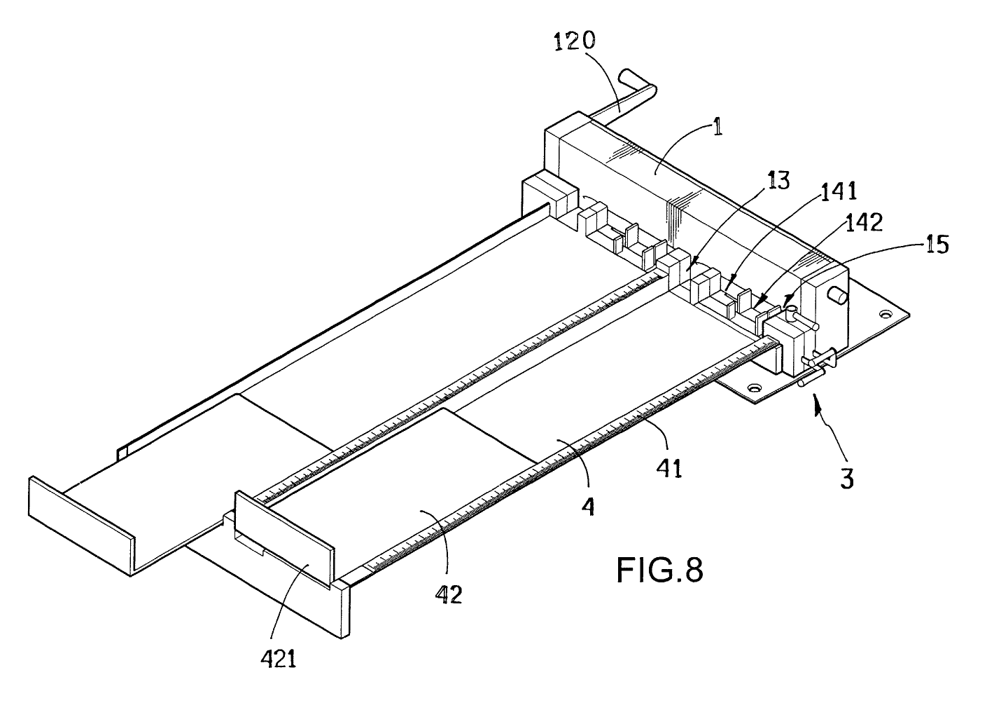

With reference now to FIG. 8, the station 1 has a feeding table 4 at rear side thereof. The lateral side of the feeding table 4 has a ruler 41 and the topside of the feeding table 4 has a sliding plate 42 to push the material to be cut and a vertical baffle plate 421. The cutting apparatus has two sets of feeding tables 4 and two sets of cutting boards and FIG. 8 only shows one set of feeding table 4 and one set of cutting board for demonstration. The station 1 has a lath-locking means 3. The sliding plate 42 is slidably arranged on the feeding table 4 and the baffle plate 421 pushes the end of the curtain laths. The curtain laths are smoothly and parallel pushed and enter the station 1 through the upper groove 13 and the front groove 141 and the rear groove 142.

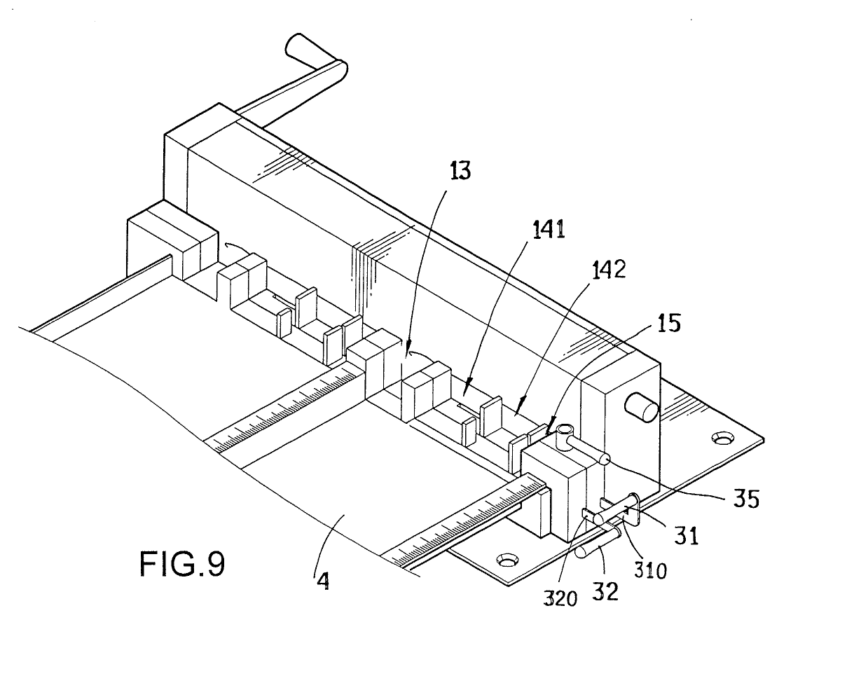

With reference now to FIG. 9, the lath-locking means 3 is used to lock the laths and two handles 31 and 32 link the pusher 310 and 320 to push the pushing plates 33 and 34. The pushing plates 33 and 34 are corresponding to the front groove 141 and the rear groove 142. When the two handles 31 and 32 are driven, to prevent the loose of the pushing plates 33 and 34, the pushers 310 and 320 are locked by a locking rod 35 to prevent the backward movement of the pushing plates 33 and 34. The locking of the locking rod 35 to prevent the backward movement of the pushing plates 33 and 34 is known art and not described in detail here.

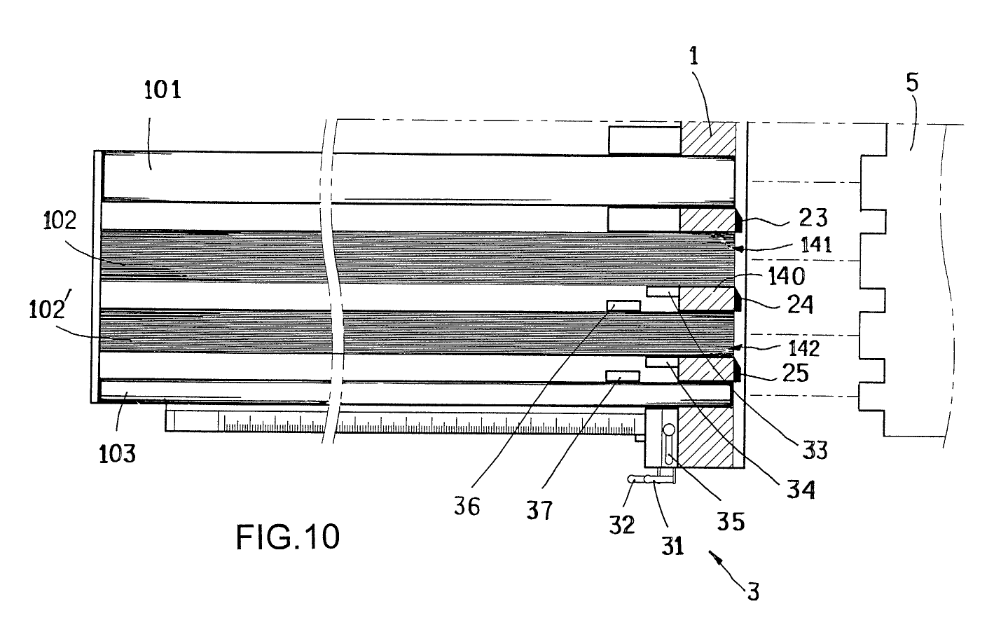

With reference now to FIG. 10, the lath-locking means 3 is used to make the two handles 31 and 32 indirectly link the pushing plates 33 and 34 such that the laths are laterally locked. The front pushing plate 33 pressed on the front laths 102. The front groove 141 and the rear groove 142 are separated by the baffle plate 140, which is coplanar to the clamping board 36. When the second pushing plate 34 pushes the rear laths 102′, the two aligned surfaces of the clamping board 36 and the baffle plate 140 provides a straight line. Therefore, the second (rear) pushing plate 34 pushes the rear laths 102′ to provide a vertical effect between the laths and the station 1. The front laths 102 are pushed by the front pushing plate 33 to provide a vertical effect between the laths and the station 1. The pushing plates 33 and 34 ensure the laths being vertical to the station 1. The laths are uniformly cut. The lath-forming blade 24 and the lower rail blade 25 can simultaneously cut the laths.

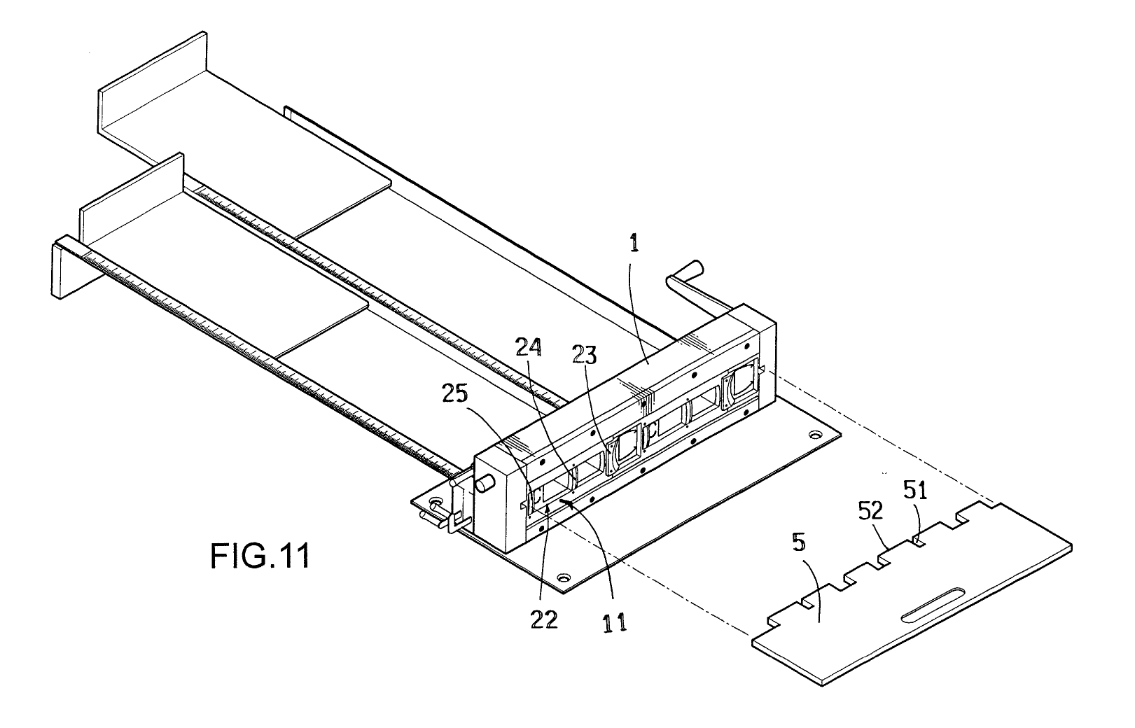

With reference now to FIG. 11, the front side of the station 1 has a block ruler 5 with a dent 51 and a top surface 42. The dent 51 receives the blades 23, 24 and 25. The top surface 42 passes through the opening 22 and abuts the cutting surface 11. The cutting surface 11 is deemed as the begin-cutting position; the block ruler 5 is pushed to initialize the lath cutting.

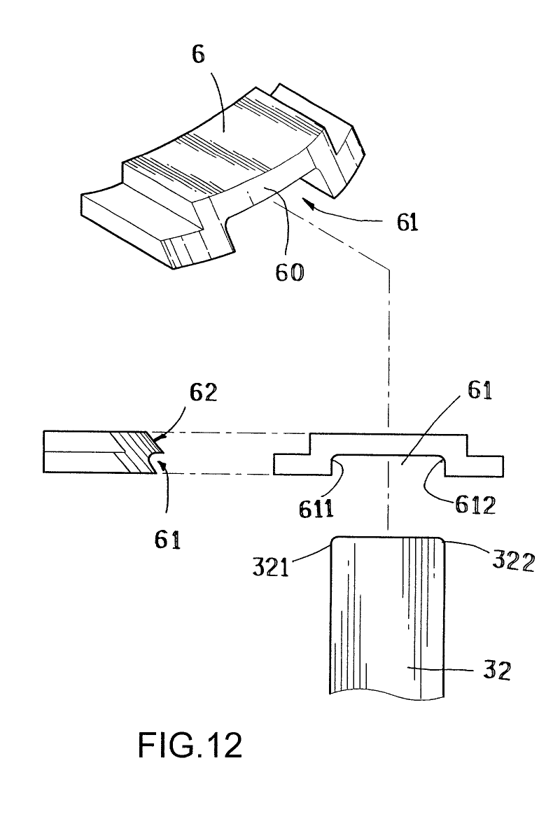

With reference now to FIG. 12, the blade can be rounded blade 6 with a cutting mouth 61 and two arced angles 611 and 612. The cutting mouth 61 has a material-ejecting side 62 to reduce cutting pressure. The two arced angles 611 and 612 are used to cut the corners 321 and 322 of the laths 102.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A cutting apparatus for transverse curtain lath, comprising
a station with grooves through which materials for curtain laths are passed;
the station having a cutting surface and the cutting surface having a cutting board sliding thereon;
the station having a longitudinal thread rod linked to a driving tenon in the station; one end of the driving tenon fit into a mortise in the cutting board
the cutting board inward pressed and locked by an upper board and a lower board; the thread rod being operated by a handle and the station having a feeding table thereon and a vertical baffle plate;
a locking means having two handles linked to two pushers to push a front pushing plate and a rear pushing plate;
the front pushing plate corresponding to a front position of the groove and the pusher is locked by a locking rod.
